(19) United States
(12) Patent Application Publication
(10) Pub. No.: US 2019/0345887 A1
(43) Pub. Date: Nov. 14, 2019

(54) VEHICLE CONTROLLING DEVICE AND VEHICLE HAVING THE SAME

(71) Applicant: HONDA MOTOR CO., LTD., Tokyo (JP)

(72) Inventors: Yoshinori AOKI, Wako-shi (JP); Kohei HANADA, Wako-shi (JP); Tomoyuki SHINMURA, Wako-shi (JP)

(21) Appl. No.: 16/406,446

(22) Filed: May 8, 2019

(30) Foreign Application Priority Data
May 10, 2018 (JP) 2018-091612

(51) Int. Cl. F02D 41/12; B60W 10/06; F02D 41/04; B60W 30/16; F02D 41/08

(52) U.S. Cl. CPC F02D 41/12; B60W 10/06; F02D 41/045; B60W 2710/065; F02D 41/042; F02D 41/08; B60Y 2300/16; B60W 30/16

(57) ABSTRACT

A vehicle controlling device comprises: a VSA-ECU which controls deceleration of a host vehicle using an inter-vehicle distance between the host vehicle and another vehicle running ahead of the host vehicle; and an engine controller which performs idling stop control to stop drive of an engine as a driving power source of the host vehicle when a stop condition, inclusive of an entry of a vehicle speed of the host vehicle into a predetermined low vehicle speed range, is satisfied, and which performs restart control to restart the engine when a predetermined restart condition is satisfied. A power supply mounted on the host vehicle is used in common as a power supply used for the deceleration control and a power supply used for the restart control. While the idling stop control is on, the VSA-ECU disables execution of the deceleration control of the host vehicle using the inter-vehicle distance.

### BACKGROUND OF THE INVENTION

### 1. Field of the Invention

The present invention relates to: a vehicle controlling device which has an idling stop function of stopping an engine as a driving power source of a host vehicle when a predetermined stop condition is satisfied; and a vehicle including the vehicle controlling device.

### 2. Description of the Related Art

A vehicle controlling device has been known which has an idling stop (hereinafter sometimes abbreviated to “IS”) function of stopping an engine as a driving power source of a host vehicle when a predetermined stop condition (for example, brake is on at zero vehicle speed) is satisfied for the purpose of reducing fuel consumption, emission, vibration noise, and the like.

As an example of such a vehicle controlling device, the present applicant discloses a vehicle controlling device invented to control a host vehicle by means of the IS function associated with a following control function of following another vehicle running ahead of the host vehicle (see, for example, Patent Literature 1).

The vehicle controlling device disclosed in Patent Literature 1 includes: an engine controller which stops an engine as a driving power source of a host vehicle when a predetermined stop condition is satisfied, and restarts the engine when a predetermined restart condition is satisfied; and a following controller which performs following control to follow another vehicle running ahead of the host vehicle when a predetermined following condition is satisfied. While the following controller is performing the following control, the engine controller operates to change the engine stop condition or restart condition from the condition used when the following control is off.

Specifically, for example, when “a road surface gradient is equal to or less than a gradient threshold” is set as the engine stop condition for the case where the following control is off, the gradient threshold used as the engine stop condition is changed to a value representing a gentler gradient while the following control is in operation. That is, when the road surface gradient is used as the engine stop condition, the engine stop timing is delayed while the following control is in operation as compared with the timing used when the following control is off.

The vehicle controlling device disclosed in Patent Literature 1 is capable of preventing the vehicle from moving down a slope road unexpectedly for the driver, because the following control and the IS control are associated to control the running of the host vehicle.

### PRIOR ART

### Patent Literature(s)

Patent Literature 1: WO2015/118570

### SUMMARY OF THE INVENTION

Patent Literature 1 states that the IS control is performed after the host vehicle stops (see paragraph 0033 in Patent Literature 1). Patent Literature 1, however, neither discloses nor suggests that the IS control is performed when the vehicle speed of the host vehicle enters a predetermined low vehicle speed range (the IS control while the host vehicle is running at slower speed).

If the IS control is performed when the vehicle speed of the host vehicle enters the predetermined low vehicle speed range, a deceleration request by deceleration control and an engine restart request are sometimes concurrently generated while the following control is in operation. Both of the deceleration request by the deceleration control and the engine restart request require relatively large power to meet the requests. For this reason, in the case where the deceleration request and the restart request are concurrently generated, it is likely that one of the requests is not satisfied to make an occupant feel discomfort.

Regarding this point, the vehicle controlling device of Patent Literature 1 does not cause a situation where the deceleration request by the deceleration control and the engine restart request are generated concurrently while the following control is in operation. The vehicle controlling device of Patent Literature 1 performs the IS control after the host vehicle stops, and drives the engine while the host vehicle is running. For this reason, no engine restart request is generated.

The present invention has been made in view of the above circumstances, and an object of the present invention is to provide a vehicle controlling device capable of realizing smooth vehicle control without making an occupant feel discomfort by preventing concurrent generation of a deceleration request by deceleration control and an engine restart request.

Another object of the present invention is to provide a vehicle which includes the controlling device capable of realizing the smooth vehicle control without making the occupant feel discomfort by preventing concurrent generation of the deceleration request by the deceleration control and the engine restart request.

For the purpose of achieving the above objects, a first aspect of the present invention is a vehicle controlling device which has main features in which the vehicle controlling device includes: a deceleration controller which controls deceleration of a host vehicle using an inter-vehicle distance between the host vehicle and another vehicle running ahead of the host vehicle; and an engine controller which performs idling stop control to stop drive of an engine as a driving power source of the host vehicle when a stop condition which includes an entry of a vehicle speed of the host vehicle into a predetermined low vehicle speed range, is satisfied, and which performs restart control to restart the engine when a predetermined restart condition is satisfied. The vehicle controlling device is further characterized in that: a power supply mounted on the host vehicle is used in common as a power supply used to execute the deceleration control and a power supply used to execute the restart control; and while the idling stop control is in operation, the deceleration controller disables execution of the deceleration control of the host vehicle using the inter-vehicle distance.

The vehicle controlling device according to the present invention is capable of realizing smooth vehicle control without making an occupant feel discomfort by preventing concurrent generation of a deceleration request by the deceleration control and an engine restart request.

### BRIEF DESCRIPTION OF THE DRAWINGS

FIG. 1 is a block diagram showing an outline of a vehicle controlling device according to an embodiment of the present invention;

FIG. 2A is an external appearance view of a manipulation switch for an adaptive cruise control function provided on a steering wheel;

FIG. 2B is an enlarged external appearance view of the manipulation switch for the adaptive cruise control function;

FIG. 3 is a flow chart diagram for explaining how the vehicle controlling device according to the embodiment of the present invention works;

FIG. 4 is a time chart diagram for explaining how the vehicle controlling device having the adaptive cruise control function woks, which shows changes over time in vehicle speed, engine revolution speed, idling stop control status, ACC operation status AEC_SET, braking status, and an AEC_SET disable flag;

FIG. 5A is a diagram showing an image used to inform an occupant that the ACC_SET status is OFF; and

FIG. 5B is a diagram showing an image used to inform an occupant that the ACC_SET status is ON.

### DETAILED DESCRIPTION OF THE EMBODIMENTS

A vehicle controlling device according to an embodiment of the present invention will be hereinafter described in detail with reference to the accompanying drawings on an as-needed basis. In the drawings shown below, basically, members sharing common functions, or members having functions corresponding to one another are denoted by the same reference sings. In addition, for the purpose of explanatory convenience, sizes and shapes of members are sometimes schematically shown with deformation or exaggeration.

### [Outline of Vehicle Controlling Device 11 According to Embodiment of Present Invention]

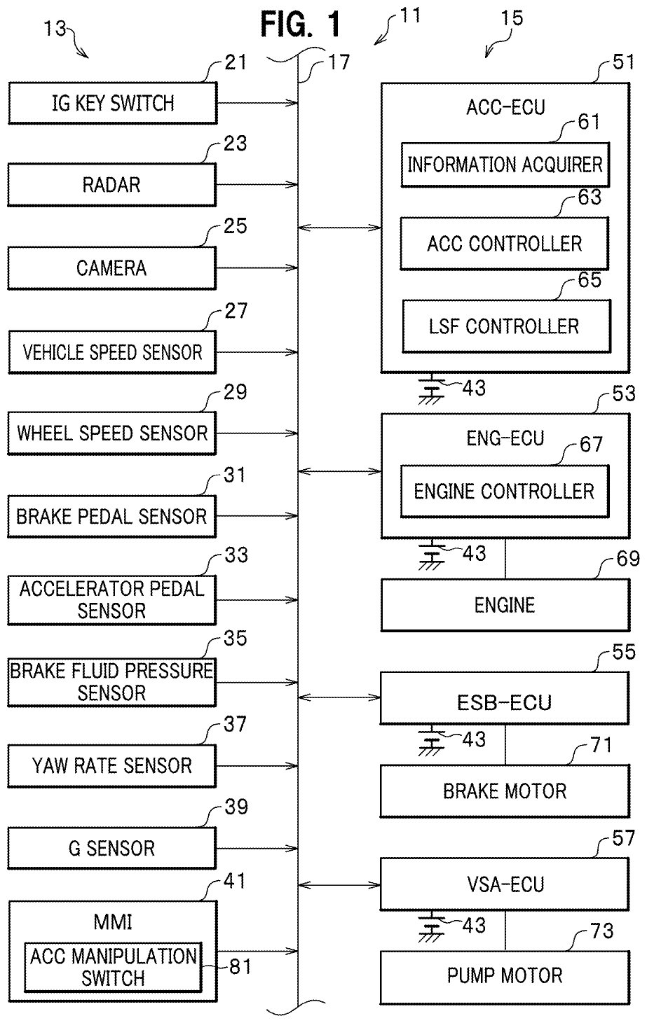

First of all, referring to FIG. 1, descriptions will be provided for an outline of the vehicle controlling device 11 according to the embodiment of the present invention. FIG. 1 is a block diagram showing the outline of the vehicle controlling device 11 according to the embodiment of the present invention.

The vehicle controlling device 11 according to the embodiment of the present invention has a function of realizing smooth vehicle control without making an occupant of a host vehicle (not shown) feel discomfort by preventing a deceleration request based on an adaptive cruise control (ACC) function and a restart request for an internal combustion engine 69 (see FIG. 1) as a driving power source of the vehicle. The ACC function will be described in detail later.

For the purpose of fulfilling the above function, as shown in FIG. 1, the vehicle controlling device 11 according to the embodiment of the present invention includes input system elements 13 and output system elements 15 which are connected together through a communication medium 17, such as a controller area network (CAN), in away that enables data to be communicated between the input system elements 13 and the output system elements 15.

As shown in FIG. 1, the input system elements 13 includes an ignition (IG) key switch 21, a radar 23, a camera 25, a vehicle speed sensor 27, a wheel speed sensor 29, a brake pedal sensor 31, an accelerator pedal sensor 33, a brake fluid pressure sensor 35, a yaw rate sensor 37, a G sensor 39, and a man-machine interface (MMI) 41.

Meanwhile, as shown in FIG. 1, the output system elements 15 includes an adaptive cruise control electronic control unit (ACC-ECU) 51, an engine ECU (ENG-ECU) 53, an electric servo brake ECU (ESB-ECU) 55, and a vehicle stability assist ECU (VSA-ECU) 57. Incidentally, VAS is a registered trade mark.

The ignition (IG) key switch 21 is a switch which is manipulated to supply power from an on-board battery 43 to the electrical components installed in the vehicle. Once the IG key switch 21 is manipulated to turn ON, the ACC-ECU 51, the ENG-ECU 53, the ESB-ECU 55 and the VSA-ECU 57 are supplied with the power, and the ECUs 51, 53, 55, 57 are activated.

The radar 23 has a function of acquiring target distribution information, including distances and directions to targets by: transmitting radar waves to the targets including another vehicle running ahead of the host vehicle; and receiving radar waves reflected off the objects.

For example, a laser radar, a micrometer-wave radar, a millimeter-wave radar, an ultrasonic-wave radar or the like may be used as the radar 23 on an as-needed basis. The radar 23 is provided on the back portion of a front grille or the like of the host vehicle. The target distribution information acquired by the radar 23 is sent to the ACC-ECU 51 via the communication medium 17.

The camera 25 has an optical axis which tilts diagonally downward in front of the host vehicle, and has a function of capturing an image of an area in a travel direction of the host vehicle. For example, a complementary metal oxide semiconductor (CMOS) camera, a charge coupled device (CCD) camera, or the like may be used as the camera 25 on an as-needed basis. The camera 25 is provided on a center upper portion of a windshield of the host vehicle, or the like. Information on the image of the area in the travel direction of the host vehicle captured by the camera 25 is converted into an interlaced image signal such as an NTSC (National Television Standards Committee) signal, and the signal is sent to the ACC-ECU 51 via the communication medium 17.

The vehicle speed sensor 27 has a function of detecting the running speed of a vehicle (vehicle speed) V. Information on the vehicle speed V detected by the vehicle speed sensor 27 is sent to the ESB-ECU 55 and the like via the communication medium 17.

The wheel speed sensor 29 has a function of detecting the revolution speed (wheel speed) of each wheel (not shown) provided to the host vehicle. Information on the wheel speed of each wheel detected by the wheel speed sensor 29 is sent to the VSA-ECU 57 and the like via the communication medium 17.

The brake pedal sensor 31 has a function of detecting an amount of depression of a brake pedal (not shown) by the driver, and an amount of torque applied by the driver. Information on the amount of depression of the brake pedal and the amount of torque detected by the brake pedal sensor 31 is sent to the ESB-ECU 55 and the like via the communication medium 17.

The acceleration pedal sensor 33 has a function of detecting an amount of depression of an acceleration pedal (not shown) by the driver. Information on the amount of depression of the acceleration pedal detected by the acceleration pedal sensor 33 is sent to the VSA-ECU 57 and the like via the communication medium 17.

The brake fluid pressure sensor 35 has a function of detecting a brake fluid pressure in a fluid supply passage of a VSA unit (vehicle behavior stabilizer; not shown) in the brake fluid pressure system. Information on the fluid pressure in the fluid supply passage of the VSA unit detected by the brake fluid pressure sensor 35 is sent to the ESB-ECU 55 and the like via the communication medium 17.

The yaw rate sensor 37 has a function of detecting a yaw rate which occurs in the host vehicle. Information on the yaw rate detected by the yaw rate sensor 37 is sent to the VSA-ECU 57 and the like via the communication medium 17.

The G sensor 39 has a function of detection a front-rear acceleration/deceleration (front-rear G) and a transverse acceleration/deceleration (transverse G) which occur in the host vehicle. Information on the front-rear G and the transverse G of the host vehicle detected by the G sensor 39 is sent to the VSA-ECU 57 and the like via the communication medium 17.

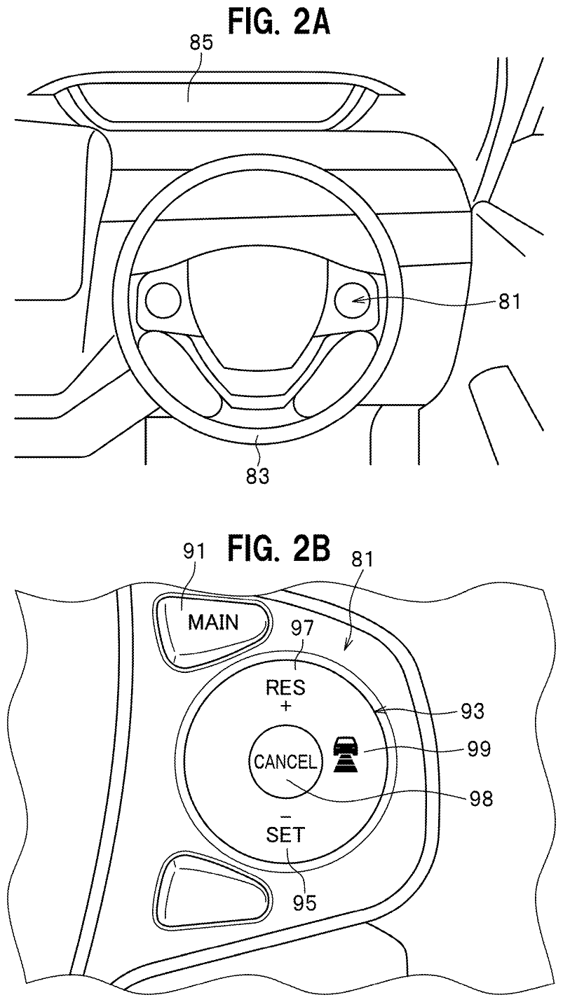

The man-machine interface (MMI) 41 includes a manipulation switch for an adaptive cruise control (ACC) function (hereinafter referred to as an “AEC manipulation switch”) 81 (see FIGS. 2A and 2B). The ACC manipulation switch 81 is used and manipulated to input set information on the ACC function. The set information on the ACC function inputted by the manipulation of the ACC manipulation switch 81 is sent to the ACC-ECU 51 and the like via the communication medium 17.

In this respect, a peripheral configuration of the ACC manipulation switch 81 will be described by referring to FIGS. 2A and 2B. FIG. 2A is an external appearance view of the ACC manipulation switch 81 provided on a steering wheel 83. FIG. 2B is an enlarged external appearance view of the ACC manipulation switch 81.

As shown in FIG. 2A, the ACC manipulation switch 81 is provided, for example, on the steering wheel 83. A multi-information display 85 which displays the vehicle speed, the shift position and the set information on the ACC function is provided near an extension line of the line of sight of the driver which extends forward in the driving direction. Detailed descriptions will be later provided for an example of how the set information on the ACC function is displayed.

Next, descriptions will be provided for the adaptive cruise control (ACC) function. The ACC function is a function of controlling the running of the host vehicle to follow the other vehicle running ahead of the host vehicle (a preceding vehicle) when a predetermined following control condition is satisfied. The conventional cruise control performs the following control with the vehicle speed V of the host vehicle kept at a set vehicle speed in a case where the vehicle speed V is set at the vehicle speed in advance.

In contrast to this, the adaptive cruise control (ACC) has the function of keeping the vehicle speed V of the host vehicle at the set vehicle speed, and additionally a function of, if a desired inter-vehicle distance is set in advance, performing the following control of keeping the inter-vehicle distance between the host vehicle and the other vehicle running ahead of the host vehicle (a preceding vehicle) at the set inter-vehicle distance while keeping the vehicle speed V of the host vehicle within a range up to the set vehicle speed.

Let us assume, for example, a case where while the ACC is in operation, the host vehicle is running at a low speed of approximately 30 Km/h in a highway because the host vehicle is trapped by traffic congestion. In this case, the vehicle speed V of the host vehicle is lower than the set speed (for example, 80 Km/h). In this situation, if the driver can use the function of following the other vehicle running ahead of the host vehicle while keeping the inter-vehicle distance between the host vehicle and the other vehicle running ahead of the host vehicle (the preceding vehicle) at the set inter-vehicle distance, the driver can feel less burden in driving and enjoy improved convenience.

For the purpose of satisfying demands for reducing the less burden and improved convenience, the ACC has a so-called low speed following (LSF) function. The LSF function is a function of performing the following control, inclusive of acceleration control and deceleration control, to keep the inter-vehicle distance between the host vehicle and the preceding vehicle at the set inter-vehicle distance without requiring the driver to operate the acceleration pedal or the brake pedal while the host vehicle is running at a low vehicle speed V (for example, 30 Km/h) lower than a set speed (for example, 80 Km/h), for example, in a highway because of a traffic jam.

To receive the set information on the ACC function through manipulation, as shown in FIG. 2B, the ACC manipulation switch 81 includes a main (MAIN) switch 91 and a circular menu switch 93. The main switch 91 is a switch to be manipulated to activate the ACC function. The circular menu switch 93 is a switch to be manipulated to input the set information on the ACC function through the manipulation.

As shown in FIG. 2B, the circular menu switch 93 includes a set (-SET) switch 95, a reset (RES+) switch 97, a cancellation (CANCEL) switch 98, and a distance switch 99.

Regarding the set information on the ACC control, the set (−SET) switch 95 is a switch to be manipulated to set the vehicle speed, and to control (reduce) the set vehicle speed.

Regarding the set information on the ACC control, the reset (RES+) switch 97 is a switch to be manipulated to reset the vehicle speed, and to control (increase) the set vehicle speed.

The cancellation (CANCEL) switch 98 is a switch to be manipulated to cancel the operation of the ACC function. Incidentally, the operation of the ACC function can be cancelled by manipulate (press) the main switch 91.

The distance switch 99 is a switch to be manipulated to set the inter-vehicle distance between the host vehicle and the preceding vehicle. The set information on the inter-vehicle distance is switched in four steps, for example, sequentially from the longest distance to the long distance, the intermediate distance and the short distance each time the distance switch 99 is manipulated (pressed). Incidentally, the embodiment employs a configuration in which the set value of the inter-vehicle distance fluctuates based on how high or low the vehicle speed V of the host vehicle is such that as the vehicle speed V becomes lower, the set value of the inter-vehicle distance becomes shorter.

As shown in FIG. 1, the ACC-ECU 51 belonging to the output system elements 15 includes an information acquirer 61, an ACC controller 63 and the LSF controller 65.

The ACC-ECU 51 is formed from a microcomputer which includes a central processing unit (CPU), a read-only memory (ROM), a random-access memory (RAM), and the like. The microcomputer operates such that: the microcomputer reads programs and data which are stored on the ROM, and executes the programs; and the microcomputer controls the execution of various functions, inclusive of the function of acquiring various pieces of information, the ACC control function and the LSF control function, which the ACC-ECU 51 has. The ACC-ECU 51 serves as a “deceleration controller” of the present invention in collaboration with the VSA-ECU 57.

The information acquirer 61 has a function of acquiring various pieces of information, inclusive of: the information on the target distribution acquired by the radar 23; the information on the image of the area in the travel direction of the host vehicle captured by the camera 25; the information on the vehicle speed V detected by the vehicle speed sensor 27; and the set information on the ACC function inputted by use of the ACC manipulation switch 81 belonging to the man-machine interface (MMI) 41.

The ACC controller 63 has a function of performing the following control, inclusive of the acceleration control and the deceleration control, with the inter-vehicle distance between the host vehicle and the preceding vehicle kept at the set inter-vehicle distance without requiring the driver to operate the acceleration pedal or the brake pedal while keeping the vehicle speed V of the host vehicle within the range up to the set vehicle speed.

The LSF controller 65 has a function of performing the following control, inclusive of the acceleration control and the deceleration control, to keep the inter-vehicle distance between the host vehicle and the preceding vehicle at the set inter-vehicle distance without requiring the driver to operate the acceleration pedal or the brake pedal while the host vehicle is running at a low vehicle speed V (for example, 30 Km/h) lower than a set speed (for example, 80 Km/h), for example, in a highway because of a traffic jam.

The ENG-ECU 53 includes an engine controller 67. The ENG-ECU 53 is formed from the microcomputer which includes the central processing unit (CPU), the read-only memory (ROM), the random-access memory (RAM), and the like. The microcomputer operates such that: the microcomputer reads programs and data which are stored on the ROM, and executes the programs; and the microcomputer controls the execution of various functions, inclusive of the engine control function, which the ENG-ECU 53 has.

The engine controller 67 has a function of controlling the drive of the engine 69 depending on the amount of depression of the acceleration pedal, and the like. To put it in detail, the engine controller 67 controls: a throttle valve (not shown) which controls an amount of intake air of the engine 69; an injector (not shown) which injects fuel gas; and an ignition plug (not shown) which ignites the fuel.

The engine controller 67 has an idling stop function of stopping the engine 69, the driving power force, of the host vehicle when a stop condition is satisfied. In this respect, for example, the vehicle speed V of the host vehicle in a low vehicle speed range (vehicle speed V<vehicle speed threshold Vis) with the brake pedal depressed but with the acceleration pedal not depressed may be employed as the “stop condition.” When the stop condition, serving as a trigger for the control to stop the engine 69, is satisfied, the engine controller 67 performs control to stop the drive of the engine 69 by, basically, regarding the satisfaction of the stop condition as the driver's intention to stop the drive of the engine 69.

The engine controller 67 further has a function of restarting the engine 69 when a predetermined restart condition is satisfied.

In this respect, for example, the depression of the accelerator pedal, and the release of the foot from the brake pedal may be employed as the “restart condition.”

The ESB-ECU 55 is formed from the microcomputer which includes the central processing unit (CPU), the read-only memory (ROM), the random-access memory (RAM), and the like. The microcomputer operates such that: the microcomputer reads programs and data which are stored on the ROM, and executes the programs; and the microcomputer controls the execution of various functions, inclusive of a braking force control function, which the ESB-ECU 55 has.

The ESB-ECU 55 has a function of: operating a motor cylinder device (see, for example, Japanese Patent Application Publication No. 2015-110378; not shown) which is driven by a brake motor 71 depending on brake fluid pressure generated in a master cylinder (not shown); and thereby generating brake fluid pressure (secondary fluid pressure).

The VSA-ECU 57 is formed from the microcomputer which includes the central processing unit (CPU), the read-only memory (ROM), the random-access memory (RAM), and the like. The microcomputer operates such that: the microcomputer reads programs and data which are stored on the ROM, and executes the programs; and the microcomputer controls the execution of various functions, inclusive of a brake control function and a vehicle posture stabilizing function based on the ACC operation, which the VSA-ECU 57 has.

The VSA-ECU 57 has, for example, a function of controlling the braking forces of the four respective wheels to make the braking forces correspond to their respective target fluid pressures by driving a pressure pump (not shown) using a pump motor 73 upon receipt of a deceleration control instruction based on the working of the LSF controller 65. The VSA-ECU 57 serves as a “deceleration controller” of the present invention in collaboration with the ACC-ECU 51.

### [Working of Vehicle Controlling Device 11 According to Embodiment of Present Invention]

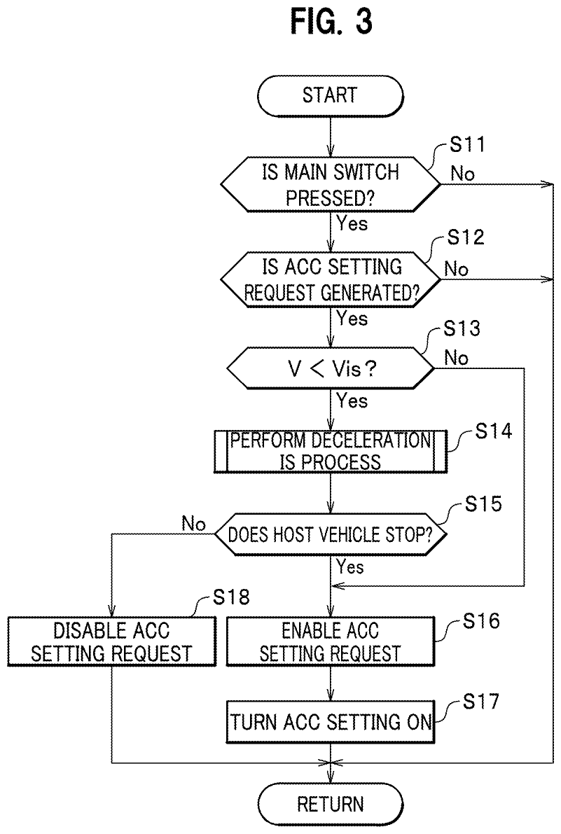

Next, referring to FIG. 3, descriptions will be provided for how the vehicle controlling device 11 according to the embodiment to the present invention works. FIG. 3 is a flow chart diagram for explaining how the vehicle controlling device 11 according to the embodiment of the present invention works.

In step S11 shown in FIG. 3, the ACC-ECU 51 determines whether the main switch 91 in the ACC manipulation switch 81 is pressed. Incidentally, the main switch 91 is a switch to be manipulated to active the ACC function. Once the ACC function is activated, the set information on the ACC function can be inputted through the manipulation. Once the set information on the ACC function is appropriately inputted through the manipulation, basically, the ACC function gets activated (ACC operation status ACC_SET, although described later, turns on).

If the result of the determination in step S11 is that the main switch 91 is pressed (if Yes in step S11), the ACC-ECU 51 makes the process flow proceed to step S12. On the other hand, if the result of the determination in step S11 is that the main switch 91 is not pressed (if No in step S11), the ACC-ECU 51 makes the process flow proceed to a return terminal.

In step S12, the ACC-ECU 51 determines whether an ACC setting request is generated. Incidentally, the determination that the ACC setting request is generated is made when the set information on the ACC function appropriately inputted through the manipulation of the circular menu switch 93 in the ACC manipulation switch 81 is acquired. In step S12, however, the ACC setting (operation) based on the acquired set information on the ACC function is disabled. To disable the ACC setting based on the acquired set information on the ACC function, an ACC_SET disable flag is used. Detailed descriptions will be provided for the ACC_SET disable flag.

If the result of the determination in step S12 is that the ACC setting request is generated (if Yes in step S12), the ACC-ECU 51 makes the process flow proceed to step S13. On the other hand, if the result of the determination in step S12 is that no ACC setting request is generated (if No in step S12), the ACC-ECU 51 makes the process flow proceed to the return terminal.

After receiving from the ACC-ECU 51 the information that the ACC setting request is generated, the ENG-ECU 53 determines in step S13 whether the vehicle speed V of the host vehicle is less than the predetermined vehicle speed threshold Vis. Incidentally, a low vehicle speed value (for example, approximately 10 Km/h) which can be regarded as implying that the host vehicle is going to stop may be employed as the predetermined vehicle speed threshold Vis on an as-need basis.

If the result of the determination in step S13 is that the vehicle speed V of the host vehicle is less than the vehicle speed threshold Vis (if Yes in step S13), the ENG-ECU 53 makes the process flow proceed to step S14. On the other hand, if the result of the determination in step S13 is that the vehicle speed V of the host vehicle is not less than the vehicle speed threshold Vis (if No in step S13), the ENG-ECU 53 makes the process flow jump to step S16.

In step S14, the engine controller 67 in the ENG-ECU 53 performs a deceleration IS process to stop the drive of the engine 69 before the host vehicle stops. Incidentally, the deceleration IS process is a process mode in which, in a case where the vehicle speed V of the host vehicle is decelerated to less than vehicle speed threshold Vis (enters the low vehicle speed range), the host vehicle is regarded as going to step and the drive of the engine 69 is stopped before the host vehicle stops.

After receiving from the ENG-ECU 53 the information that the ENG-ECU 53 is performing the deceleration IS process, the ACC-ECU 51 determines in step S15 whether the host vehicle stops.

If the result of the determination in step S15 is that the host vehicle stops (if Yes in step S15), the ACC-ECU 51 makes the process flow proceed to step S16. On the other hand, if the result of the determination in step S15 is that the host vehicle does not stop yet (if No in step S15), the ACC-ECU 51 makes the process flow jump to step S18.

In step S16, the ACC-ECU 51 enables the ACC setting request. The enabling of the ACC setting request is done by switching the ACC_SET disable flag from disable to enable.

In step S17, the ACC-ECU 51 turns the ACC operation status ACC_SET on. Thereby, the ACC is set (operated) based on the set information on the ACC function acquired in the case where it is determined in step S12 that the ACC setting request is generated. Thereafter, the ACC-ECU 51 makes the process flow proceed to the return terminal.

In step S18, the ACC-ECU 51 disables the ACC setting request. The disabling of the ACC setting request is done by keeping the ACC_SET disable flag at disable status. Thereafter, the ACC-ECU 51 makes the process flow proceed to the return terminal.

### [Time-Series Operation of Vehicle Controlling Device 11 According to Embodiment of Present Invention]

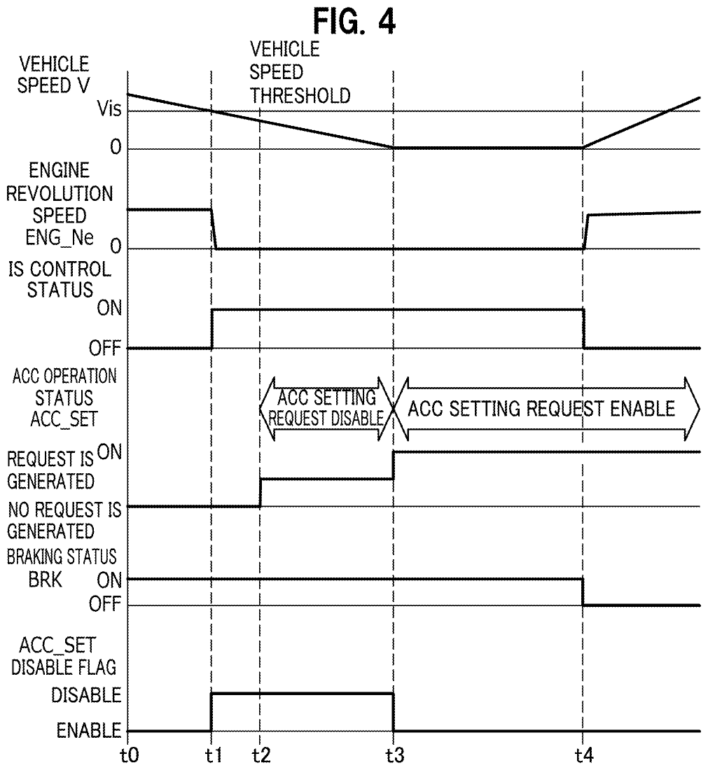

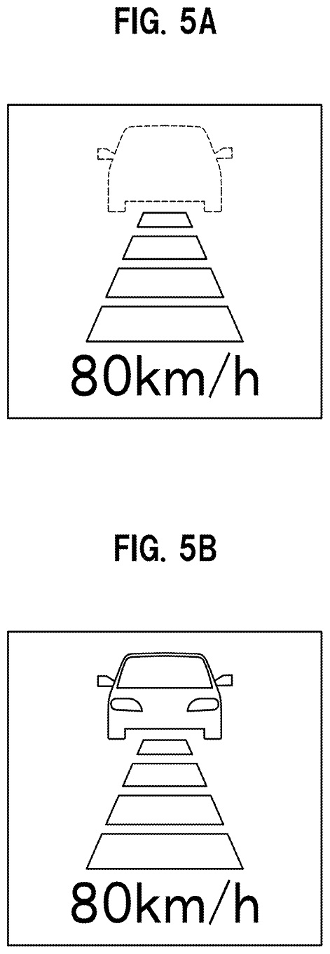

Next, referring to FIGS. 4, 5A and 5B, descriptions will be provided for time-series operation of the vehicle controlling device 11 according to the embodiment of the present invention.

FIG. 4 is a time chart diagram for explaining how the vehicle controlling device 11 having the adaptive cruise control (ACC) function woks, which shows changes over time in the vehicle speed V, engine revolution speed ENG_Ne, IS control status, the ACC operation status ACC_SET, braking status BRK, and the ACC_SET disable flag. FIG. 5A is a diagram showing an image used to inform the occupant that the ACC_SET status is OFF. FIG. 5B is a diagram showing an image used to inform the occupant that the ACC_SET status is ON.

As shown in FIG. 4, between time t0 and time t1, the vehicle speed V of the host vehicle linearly decreases gradually from a value exceeding the vehicle value threshold Vis until the vehicle speed V enters the low vehicle speed range whose upper limit is the vehicle speed threshold Vis. During this time period, the engine revolution speed ENG_Ne is held at an idling revolution speed. The IS control status representing whether the idling stop control is ON or OFF is in OFF status. The ACC operation status ACC_SET is “no request is generated.” The braking status BRK representing whether the brake pedal is being depressed is in ON status (the brake pedals is being depressed). The ACC_SET disable flag representing whether to disable or enable the turning on of the ACC operation status ACC_SET is in ENABLE status.

Between time t1 and time t3, the vehicle speed V of the host vehicle at time t1 enters the low vehicle speed range whose upper limit is the vehicle speed threshold Vis, and thereafter continues linearly decrease gradually until the vehicle speed V becomes equal to zero (the host vehicle stops) at time t3. During this time period, the engine revolution speed ENG_Ne quickly drops to zero immediately after time t1, and thereafter is kept at zero (the drive of the engine 69 is being stopped). The IS control status shifts from OFF status to ON status at time t1, and thereafter is kept in ON status. The ACC operation status ACC_SET is kept in “no ACC setting request is generated” between time t1 and time t2, and thereafter shifts from “no ACC setting request is generated” to “ACC setting request is generated” at time t2 (based on the occurrence of the ACC setting request in accordance with the occupant's input of the ACC setting request by manipulating the ACC manipulation switch 81), as well as subsequently is kept in “ACC setting request is generated.” The braking status BRK is kept in ON status (the brake pedal is being depressed). The ACC_SET disable flag shifts from ENABLE status to DISABLE status at time t1, and thereafter is kept in DISABLE status.

There are two important points between time t1 and time t3. A first point is that at time t1, the shift of the ACC_SET disable flag from ENABLE status to DISABLE status synchronizes with the shift of the IS control status from OFF status to ON status. This is based on a requirement that while the idling stop control is in “On status” and the drive of the engine 69 is being stopped, basically, the turning on of the ACC operation status ACC_SET be disabled in order to prevent concurrent generation of the deceleration request by the ACC function and the restart request for the engine 69.

A second point is that although the ACC operation status ACC_SET shifts from “no ACC setting request is generated” to “ACC setting request is generated” at time t2, the turning on of the ACC operation status ACC_SET is disabled (the ACC setting request is disabled). This operation is realized by holding the ACC_SET disable flag in DISABLE status between time t1 to time t3. Incidentally, the shift of the ACC_SET disable flag from ENABLE status to DISABLE status at time t1 is based on the shift of the IS control status from OFF status to ON status at time t1, as discussed above.

Incidentally, during an ACC setting request disable period between time t2 and time t3, information that the ACC setting request disable period is going on is displayed on the multi-information display 85 using a scheme (see FIG. 5A) in which an outline of the vehicle representing the ACC setting status is unclearly shown by being drawn with a dotted line. Thereby, the occupant can be informed that the ACC setting request inputted by the occupant through the manipulation of the ACC manipulation switch 81 is not accepted.

Between time t3 and time t4, the vehicle speed V of the host vehicle is kept at zero (the host vehicle is being stopped). During this time period, the engine revolution speed ENG_Ne is also kept at zero (the drive of the engine 69 is being stopped). The IS control status is kept in ON status. The ACC operation status ACC_SET shifts from “ACC setting request is generated” to “ACC set on” at time t3, and thereafter is kept in “ACC set on status.” The braking status BRK is kept in ON status (the brake pedal is being depressed). The ACC_SET disable flag is kept in Enable status.

An important point between time t3 and time t4 is that the ACC operation status ACC_SET shifts from “ACC setting request is generated” to “ACC set on” at time t3. This shift is based on a shift of the ACC_SET disable flag from DISABLE status to ENABLE status in response to a situation where there is no risk of concurrent generation of the deceleration request by the ACC function and the restart request for the engine 69 because the vehicle speed of the host vehicle becomes equal to zero (the host vehicle stops) at time t3.

After time t4, the vehicle speed V of the host vehicle linearly increases gradually from zero (the host vehicle is being stopped). The engine revolution speed ENG_Ne quickly rises to the idling revolution speed immediately after time t4, and thereafter is kept at around the idling revolution speed. The IS control status shifts from ON status to OFF status at time t4, and thereafter is kept in OFF status. The ACC operation status ACC_SET is kept in ON status. The braking status BRK shifts from ON status (the brake pedal is being depressed) to OFF status (the foot is off the brake pedal), and thereafter is kept in OFF status. The ACC_SET disable flag is kept in ENABLE status.

What needs to be additionally explained about the operation on and after time t4 is that at time t4, the shift of the braking status BRK from ON status to OFF status (the restart condition is satisfied) triggers the shift of the IS control status from ON status to OFF status, and the restarting of the engine 69. Incidentally, various cases which enables the vehicle controlling device to find out that driver is going to start the host vehicle may be set as the case where the condition for restarting the engine 69 is satisfied. Example of such cases include: the shift of the braking status BRK from ON status to OFF status (the foot comes off the brake pedal); the depression of the acceleration pedal; the manipulation of the steering switch; and application of steering torque exceeding a predetermined value to the steering wheel.

Incidentally, during an ACC setting request enable period coming after time t3, information that the ACC setting request enable period is going on is displayed on the multi-information display 85 using a scheme (see FIG. 5B) in which the outline of the vehicle representing the ACC setting status is clearly shown by being drawn with a solid line. Thereby, the occupant can be informed that the ACC setting request inputted by the occupant through the manipulation of the ACC manipulation switch 81 is accepted.

### [Working of and Effects Brought by Vehicle Controlling Device 11 According to Embodiment of Present Invention]

Next, descriptions will be provided for how the vehicle controlling device 11 according to the embodiment of the present invention works and what effects the vehicle controlling device 11 brings about. The vehicle controlling device 11 based on a first aspect employs the following configuration. The vehicle controlling device 11 includes: the ACC-ECU 51 and the VSA-ECU 57 (jointly forming the deceleration controller) which performs the deceleration control of the host vehicle using the inter-vehicle distance between the host vehicle and the other vehicle running ahead of the host vehicle; and the engine controller 67 which performs the idling stop control to stop the drive of the engine 69 as the driving power source of the host vehicle when the stop condition, inclusive of the entry of the vehicle speed V of the host vehicle into the predetermined low vehicle speed range, is satisfied, and which performs the restart control to restart the engine 69 when the predetermined restart condition is satisfied. The single power supply 43 installed in the host vehicle is used in common as the power supply 43 used to perform the deceleration control, and the power supply 43 used to perform the restart control. While the idling stop control is in operation, the ACC-ECU 51 and the VSA-ECU (jointly forming the deceleration controller) disables the execution of the deceleration control of the host vehicle using the inter-vehicle distance.

A precondition is that both the deceleration request by the deceleration control and the restart request for the engine 69 require relatively large electric power to be satisfied. For this reason, if the deceleration request and the restart request are generated concurrently while the single power supply 43 installed in the host vehicle is used in common as the power supply 43 used to perform the deceleration control and the power supply 43 used to perform the restart control, one of the deceleration request and the restart request may not be satisfied because of the insufficient capacity of the power supply 43 and make the occupant feel discomfort.

Regarding this point, the vehicle controlling device 11 according to a first aspect is configured such that the ACC-ECU 51 and the VSA-ECU 57 (jointly forming the deceleration controller) disables the execution of the deceleration control of the host vehicle using the inter-vehicle distance while the idling stop control is in operation. The vehicle controlling device 11, therefore, does not execute the deceleration control while the drive of the engine 69 is stopped. Accordingly, there is no possibility of concurrent generation of the deceleration request by the deceleration control and the restart request for the engine 69.

The vehicle controlling device 11 according to the first aspect prevents concurrent generation of the deceleration request by the deceleration control and the restart request for the engine, and is thus capable of realizing the smooth vehicle control without making the occupant feel discomfort. In addition, since the vehicle controlling device 11 is capable of inhibiting the total amount of load imposed on the power supply 43, a secondary effect of reducing the capacity of the power supply 43 (which means a reduction in the weight of the power supply 43) can be expected from the vehicle controlling device 11.

Furthermore, a vehicle controlling device 11 according to a second aspect is the vehicle controlling device 11 according to the first aspect, and may employ a configuration in which when the host vehicle enters the stop condition, the ACC-ECU 51 and the VSA-ECU (jointly forming the deceleration controller) enables the execution of the deceleration control of the host vehicle using the inter-vehicle distance.

The vehicle controlling device 11 according to the second aspect is configured such that in the case where the host vehicle enters the stop condition, the ACC-ECU 51 and the VSA-ECU 57 (jointly forming the deceleration controller) enables the execution of the deceleration control of the host vehicle using the inter-vehicle distance. Even if the idling stop control is in operation (the drive of the engine 69 is stopped), after the host vehicle enters the stop condition, the deceleration request by the deceleration control is no longer generated. For this reason, even if the restart request for the engine 69 is generated due to the execution of the idling stop control after the host vehicle enters the stop condition, the deceleration request by the deceleration control is not generated concurrently.

In addition to the effect from the vehicle controlling device 11 according to the first aspect, an effect of reducing the amount of fuel consumption can be expected from the vehicle controlling device 11 according to the second aspect.

Moreover, a vehicle controlling device 11 according to a third aspect is the vehicle controlling device 11 according to the first aspect, and may employ a configuration in which: the ACC-ECU 51 and the VSA-ECU 57 (jointly forming the deceleration controller) performs the deceleration control of the host vehicle using a difference between a preset demanded inter-vehicle distance and an actual inter-vehicle distance between the host vehicle and the other vehicle running ahead of the host vehicle; the engine controller 67 further performs the acceleration control of the host vehicle using the difference between the demanded inter-vehicle distance and the actual inter-vehicle distance; and while the idling stop control is in operation, the ACC-ECU 51 and the VSA-ECU 57 (jointly forming the deceleration controller) disables the execution of the following control which includes the deceleration control and the acceleration control using the difference.

Since while the idling stop control is in operation, the ACC-ECU 51 and the VSA-ECU 57 (jointly forming the deceleration controller) disables the execution of the ACC control (following control), including the deceleration control and the acceleration control using the difference, the vehicle controlling device 11 according to the third aspect prevents concurrent generation of the deceleration request by the ACC control (following control) and the restart request for the engine, and is thus capable of realizing the smooth vehicle control without making the occupant feel discomfort. In addition, since the vehicle controlling device 11 is capable of inhibiting the total amount of load imposed on the power supply 43, the secondary effect of reducing the capacity of the power supply 43 (which means a reduction in the weight of the power supply 43) can be expected from the vehicle controlling device 11.

A vehicle controlling device 11 according to a fourth aspect may employ the following configuration. The vehicle controlling device 11 includes: the VSA-ECU (deceleration controller) 57 which performs the deceleration control of the host vehicle using the difference between the preset demanded inter-vehicle distance and the actual inter-vehicle distance between the host vehicle and the other vehicle running ahead of the host vehicle; and the engine controller 67 which performs the idling stop control to stop the drive of the engine 69 as the driving power source of the host vehicle when the stop condition, inclusive of the entry of the vehicle speed of the host vehicle into the predetermined low vehicle speed range, is satisfied, and which performs the restart control to restart the engine 69 when the predetermined restart condition is satisfied. The single power supply 43 installed in the host vehicle is used in common as the power supply 43 used to perform the deceleration control, and the power supply 43 used to perform the restart control. While the idling stop control is in operation, the ACC-ECU 51 and the VSA-ECU 57 (jointly forming the deceleration controller) disables the execution of the following control which includes the deceleration control and the acceleration control using the difference.

In the vehicle controlling device 11 according to the fourth aspect, while the idling stop control is in operation, the ACC-ECU 51 and the VSA-ECU 57 (jointly forming the deceleration controller) disables the execution of the following control, including the deceleration control and the acceleration control using the difference.

Since the execution of the ACC control (following control) including the deceleration control and the acceleration control is disabled while the idling stop control is in operation, the vehicle controlling device 11 according to the fourth aspect prevents concurrent generation of the deceleration request by the ACC control (following control) and the restart request for the engine, and is thus capable of realizing the smooth vehicle control without making the occupant feel discomfort. In addition, since the vehicle controlling device 11 is capable of inhibiting the total amount of load imposed on the power supply 43, the secondary effect of reducing the capacity of the power supply 43 (which means a reduction in the weight of the power supply 43) can be expected from the vehicle controlling device 11.

Besides, a vehicle according to a fifth aspect includes the vehicle controlling device 11 according to any one of the first to fourth aspects.

According to the vehicle of the fifth aspect, it is possible to provide a vehicle which prevents concurrent generation of the deceleration request by the deceleration control and the restart request for the engine and is thus capable of realizing the smooth vehicle control without making the occupant feel discomfort.

### [Other Embodiments]

The above-discussed embodiments show example of how the present invention is embodied. The embodiments, therefore, shall not be construed as limiting the technical scope of the present invention. This is because the present invention can be carried out in various modes without departing from the spirit or main feature of the present invention.

For example, how the vehicle controlling devices 11 according to the embodiments of the present invention work has been explained (see FIG. 3) by showing an example of the mode: the ACC-ECU 51 determines whether the main switch 91 (to be manipulated to activate the ACC function) in the ACC manipulation switch 81 is pressed; and once the main switch 91 is pressed (the ACC function is activated), the manipulation to input the set information on the ACC function is enabled. The present invention, however, is not limited to this example.

The main switch 91 may be omitted from the ACC manipulation switch 81. This omission leads to the omission of step S11. In this case, a configuration may be employed in which when the ACC-ECU 51 acquires the set information on the ACC function based on the appropriate input manipulation of the circular menu switch 93 in the ACC manipulation switch 81 (the ACC setting request), the acquisition is regarded as the pressing of the main switch 91.

Furthermore, a configuration may be employed in which in a case where the main switch 91 in the ACC manipulation switch 81 is ON (the ACC function is activated) before the start of the deceleration IS process (see step S14 in FIG. 3), control for forcibly turning off the main switch 91 in response to the start of the deceleration IS process is performed in order to disable the turning on of the ACC operation status ACC_SET.

Besides, the vehicle controlling devices 11 according to the embodiments of the present invention have been explained by showing the example in which the function of generating the control signal (the ACC_SET disable flag) for enabling or disabling the turning on of the ACC operation status ACC_SET is assigned to the ACC-ECU 51. The present invention, however, is not limited to this example.

The present invention may employ a configuration in which the function of generating the control signal (the ACC_SET disable flag) for enabling or disabling the turning on of the ACC operation status ACC_SET is assigned to the vehicle controlling device 11 itself instead of the ACC-ECU 51. In this case, the vehicle controlling device 11 corresponds to the “deceleration controller” of the present invention.

Moreover, the vehicle controlling devices 11 according to the embodiments of the present invention have been explained by showing the example in which the function of performing the deceleration control of the host vehicle using the inter-vehicle distance between the host vehicle and the other vehicle running ahead of the host vehicle is assigned to the VSA-ECU 57. The present invention, however, is not limited to this example

The present invention may employ a configuration in which the function of performing the deceleration control of the host vehicle using the inter-vehicle distance between the host vehicle and the other vehicle running ahead of the host vehicle is assigned to the vehicle controlling device 11 itself instead of the VSA-ECU 57.

What is claimed is:

1. A vehicle controlling device comprising:
a deceleration controller which performs deceleration control of a host vehicle using an inter-vehicle distance between the host vehicle and another vehicle running ahead of the host vehicle; and
an engine controller which performs idling stop control to stop drive of an engine as a driving power source of the host vehicle when a stop condition, inclusive of an entry of a vehicle speed of the host vehicle into a predetermined low vehicle speed range, is satisfied, and which performs restart control to restart the engine when a predetermined restart condition is satisfied, wherein
a power supply mounted on the host vehicle is used in common as a power supply used to execute the deceleration control and a power supply used to execute the restart control, and
while the idling stop control is in operation, the deceleration controller disables execution of the deceleration control of the host vehicle using the inter-vehicle distance.

2. The vehicle controlling device according to claim 1, wherein when the host vehicle enters a stop condition, the deceleration controller enables execution of the deceleration control of the host vehicle using the inter-vehicle distance.

3. The vehicle controlling device according to claim 1, wherein
the deceleration controller performs the deceleration control of the host vehicle using a difference between a preset demanded inter-vehicle distance and an actual inter-vehicle distance between the host vehicle and the other vehicle running ahead of the host vehicle,
the engine controller further performs acceleration control of the host vehicle using the difference between the demanded inter-vehicle distance and the actual inter-vehicle distance, and
while the idling stop control is in operation, the deceleration controller disables execution of following control which includes the deceleration control and the acceleration control using the difference.

4. A vehicle controlling device comprising:
a deceleration controller which performs deceleration control of a host vehicle using a difference between a preset demanded inter-vehicle distance and an actual inter-vehicle distance between the host vehicle and another vehicle running ahead of the host vehicle; and
an engine controller which performs idling stop control to stop drive of an engine as a driving power source of the host vehicle when a stop condition, inclusive of an entry of a vehicle speed of the host vehicle into a predetermined low vehicle speed range, is satisfied, and which performs restart control to restart the engine when a predetermined restart condition is satisfied, wherein
a power supply mounted on the host vehicle is used in common as a power supply used to execute the deceleration control and a power supply used to execute the restart control,
the engine controller further performs acceleration control of the host vehicle using the difference between the demanded inter-vehicle distance and the actual inter-vehicle distance, and
while the idling stop control is in operation, the deceleration controller disables execution of following control which includes the deceleration control and the acceleration control using the difference.

5. A vehicle comprising the vehicle controlling device according to claim 1.

6. A vehicle comprising the vehicle controlling device according to claim 4.
